(19) United States
(12) Patent Application Publication
(10) Pub. No.: US 2015/0338075 A1
(43) Pub. Date: Nov. 26, 2015

(54) LED PROJECTOR LAMP MODULE

(71) Applicant: SHENZHEN YAORONG TECHNOLOGY CO., LTD, Shenzhen, Guangdong (CN)

(72) Inventor: Zhiping MA, Shenzhen, Guangdong Province (CN)

(73) Assignee: SHENZHEN YAORONG TECHNOLOGY CO., LTD., Shenzhen, Guangdong Province (CN)

(21) Appl. No.: 14/759,226

(22) PCT Filed: May 28, 2013
(86) PCT No.: PCT/CN2013/076321

§ 371 Date: Jul. 4, 2015

(30) Foreign Application Priority Data
Jan. 4, 2013 (CN) 201320000112.8

(51) Int. Cl. F21V 23/00; F21V 17/12; F21V 29/507; F21S 2/00; F21V 21/14; F21V 31/00; F21V 29/76

(52) U.S. Cl. CPC F21V 23/008; F21V 31/00; F21V 17/12; F21V 29/763; F21S 2/005; F21V 21/14; F21V 29/507; F21Y 2101/02

(57) ABSTRACT

A Light Emitting Diode (LED) Projector Lamp Module comprises at least one LED Projector Lamp (1) and further comprises a profiled power source box (12) connected and fixed to one or more flood lamps and it includes a plurality of power source output lines (131) electrically connected to each LED Projector Lamp (11) in a waterproof plug-in mode. The LED Projector Lamp Module is of a modular structure, and the power source box (12) is of profiled structure with freedom of increasing length; therefore, the invention reduces investment of mold and lowers cost. The profiled power source box (12) electrically connects to each LED Projector Lamp (11) in a plug-in mode, to allow for independent removal and convenient maintenance. Radiators (117) are set in the front and the back of the LED Projector Lamp (11), to increase the effective heat dissipation area and improve air flow.

### TECHNICAL FIELD

The invention is related to a Light Emitting Diode (LED) Projector Lamp, especially involves a LED Projector Lamp Module.

### BACKGROUND ART

Projector Lamp is also called projection lamp, spot lamp, flood lamp and so on, Light Emitting Diode Projector Lamp is mainly used for building decoration lighting and commercial space lighting.

The die-cast Projector Lamps in prior art are all provided with single lamp shell and the power source box is also die-cast, so the power of the lamp is difficult to change. If the luminous power is needed to increase, it can be only achieved via the array form of Light Emitting Diode Projector Lamp, and a number of simple sealed Light Emitting Diode Projector Lamps are put together, which increases the volume of the lamp and the power of the lamp is not easy to adjust.

Therefore, the Projector Lamp Module is needed to improve the power of the light.

### CONTENT OF THE INVENTION

The technical problem the invention aims to settle lies in avoiding the deficiencies of the prior art so as to provide a Light Emitting Diode Projector Lamp Module with the advantages of low cost, convenient maintenance and fast heat dissipation.

In order to achieve the above purpose, the invention of a Light Emitting Diode Projector Lamp Module comprising at least two Light Emitting Diode Projector Lamps, wherein, the Light Emitting Diode Projector Lamp Module further comprises a profiled power source box; the power source box comprises a plurality of power source output lines which are electrically connected to each Light Emitting Diode Projector Lamp to supply the power.

Wherein, the optimum proposal is as follows: said power source box is of extensile profiled structure, the power source is fixed into an independent sealed profile structure by means of fixing structures on the two ends of the profiled structure.

Wherein, the optimum proposal is as follows: said fixing structure comprises a power source stator adapted to fix the power source, a connecting bracket, a power source baffle and a spinning cover; wherein said power source stator fixed with power source is put into the power source box and said power source stator is held by the power source baffle and the spinning cover at two ends, wherein the two ends of the connecting bracket are adapted to clamp the spinning covers, and connect to the spinning covers through thread fastening.

Wherein, the optimum proposal is as follows: said fixing structure also comprises a waterproof ring, whose shape matches with the section of the power source box.

Wherein, the optimum proposal is as follows: said power source box is electrically connected to each Light Emitting Diode Projector Lamp in a waterproof plug-in mode.

Wherein, the optimum plan is as follows: said Projector Lamp comprises the Light Emitting Diode light source equipped inside the lamp box and a radiator equipped at the back-end of the lamp frame, wherein that a heat sink is set at the front-end of the Light Emitting Diode light source.

Advantages of the invention:
1. The lamp adopts module structure, and the power source box is of profiled structure with freedom of increasing length, thus change the power of the lamp only need to add the number of the modules, an additional mold is not required, therefore, reducing investment of mold and lowering cost.
2. The power source box connects with each Light Emitting Diode Projector Lamp in a plug-in mode, allowing for independent removal and convenient maintenance.
3. Each Light Emitting Diode Projector Lamp is equipped with radiator at its front and back, increasing the effective heat dissipation area and making better air flow, so as to achieve better dissipation effect.

### DESCRIPTIONS OF FIGURES

FIG. 1 is a plane graph of the Light Emitting Diode Projector Lamp Module of the invention;

FIG. 2 is an explosive view of the Light Emitting Diode Projector Lamp Module of the invention.

### DETAILED EMBODIMENTS

The following are the detailed embodiments of the invention with combination of the figures.

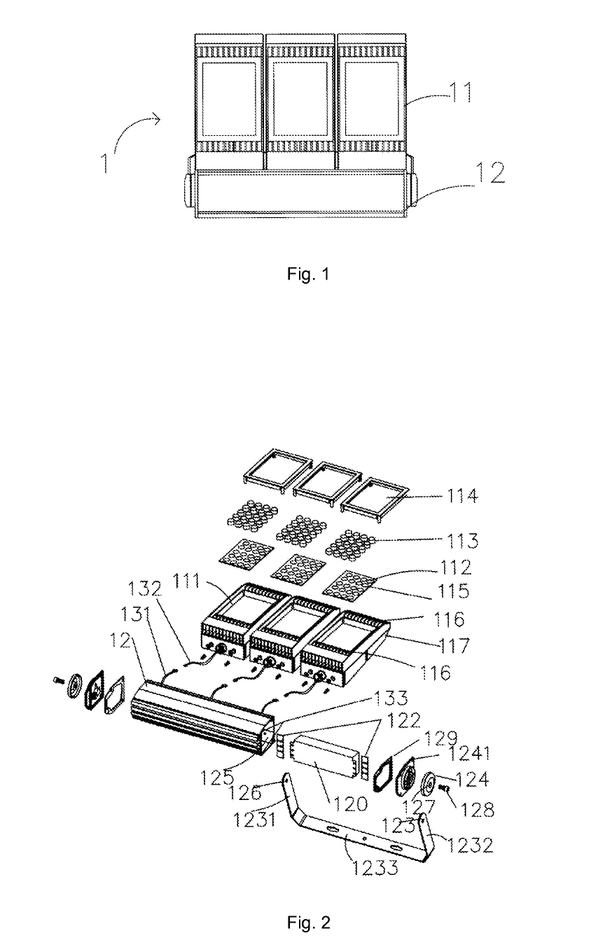

Referring to FIG. 1 and FIG. 2, the technical proposal of the Light Emitting Diode Projector Lamp Module is: the module 1 comprises a number of Light Emitting Diode Projector Lamps 11 and a power source box 12. The embodiment only reveals the embodiment mode with three Light Emitting Diode Projector Lamps 11, according to the requirement of the power, it can connect a number of Light Emitting Diode Projector Lamps 11.

Wherein, said Light Emitting Diode Projector Lamp 11 comprises a lamp frame 111 adapted to orderly accommodate a Light Emitting Diode luminous chip 112, an array lens 113 equipped according to the arrangement of Light Emitting Diode luminous chip 112, and a glass sheet 114. Said luminous chip 112 array is set on a aluminum substrate 115, and the reflected beam of the Light Emitting Diode luminous chip 112 passes through the glass sheet 114 via convergence of lens 113; wherein, a number of heat sinks 116 are installed on the surface of said lamp frame 111 is installed with, meanwhile, a radiator 117 is installed on the bottom of the lamp frame 111, since not only said heat sinks 116 are set on the surface of the Light Emitting Diode Projector Lamp 11, but also a radiator 117 is set on the top of the Light Emitting Diode Projector Lamp 11, in this way, the convection is formed between the front and back of Light Emitting Diode Projector Lamp 11, so as to achieve a better heat dissipation effect.

Wherein, said power source box 12 is of extensile profiled structure, due to the inherent characteristic of the profile, the length of said power source box 12 can be freely lengthened and shortened as required; the power source 120 is fixed into an independent sealed profiled structure, by means of the fixing structures 121 on the two ends of the profiled structure. Said fixing structure 121 comprises a power source stator 122 adapted to fix the power source, a connecting bracket 123, a battery box baffle 1241 and a spinning cover 124, said power source stator 122 fixed with power source is put into a receiving hole 125 of the power source box 12; wherein said connecting bracket 123 comprises three continuous sections; the first section 1231 and the second section 1232 are respectively almost vertical to the third section 1233, Wherein, said first section 1231 and the second section 1232 are set with a thread through-hole 126, Wherein, in order to have a better fastening effect, the length of the third section 1233 is set as the length of power source box 12 is the best. A thread hole 127 is in the center of said spinning cover 124, which matches with a fixing bolt 128. Wherein, the fixed mode of said fixing structure 121 is as follows: firstly fix the power source 120 on the power source stators 122, then put it into the receiving hole 125; use the symmetrical spinning covers 124 to hold against said stators 122; the bolts 128 pass the thread through-holes 126 on the left and right of the connecting bracket 123, reaching to the thread holes 127 of the spinning covers 124, swivel bolts 128, entering into the thread holes 127 of the spinning covers; by using the first section 1231 and the second section 1232 of the connecting bracket 123, the connecting bracket 123 clamps towards the center of the power source box 12, so as to achieve the purpose of fixing.

In order to get a better sealed effect of the power source box 12, the fixing structure also comprises a waterproof ring 129, whose shape matches with the section of the power source box, at the same time, the lamp frame is also equipped with a waterproof ring, all having waterproof effects, no more description is needed.

In order to fix the power source 120 without shaking in the power source box 12, the power source box 12 comprises a power card slot 133, and the stator 122 can plug into the power card slot 133, making the power source 120 not shake in the power source box 12.

In order to achieve the electrical connection of the power source box 12 with each Light Emitting Diode Projector Lamps 11, the power source box 12 is set with a number of power source output lines 131, the corresponding Light Emitting Diode Projector Lamp 11 is equipped with corresponding quantity of power source input lines 132, the power source output lines 131 and the power source input lines 132 are connected in the plug-in mode.

Advantages of the invention:
1. The lamp adopts module structure, and the power source box 12 is of profiled structure with freedom of increasing length, in this way, change the power of the lamp only need to add the number of the modules, an additional mold is not required, therefore, reducing investment of mold and lowering cost.
2. The power source box 12 connects with each Light Emitting Diode Projector Lamp 11 in a plug-in method, allowing for allowing for independent removal and convenient maintenance.
3. Each Light Emitting Diode Projector Lamp 11 is equipped with radiator at its front and back, increasing the effective heat dissipation area and making better air flow, so as to achieve better dissipation effect.

The above is only the best embodiments of the invention, and not used to limit the range of the invention; the equivalent changes and modification all in accordance with the range of invention are covered in this disclosure.

What is claimed is:

1. A Light Emitting Diode Projector Lamp Module comprising at least one Light Emitting Diode Projector Lamp, wherein the Light Emitting Diode Projector Lamp Module further comprises a profiled power source box with a plurality of power source output lines, wherein the power source output lines are electrically connected to each Light Emitting Diode Projector Lamp.

2. The Projector Lamp Module according to claim 1, wherein the power source box is of extensile profiled structure, wherein the power source is fixed into the independent sealed profile structure by means of fixing structures on the two ends of the profiled structure.

3. The Projector Lamp Module according to claim 2, wherein said fixing structure comprises a power source stator adapted to fix the power source, a connecting bracket, a power source baffle and a spinning cover, wherein said power source stator fixed with power source is put into the power source box and said power source stator is held by the power source baffle and the spinning cover at two ends, wherein the two ends of the connecting bracket are adapted to clamp the spinning covers and connect to the spinning covers through thread fastening.

4. The Projector Lamp Module according to claim 2, wherein the fixing structure comprises a waterproof ring, whose shape matches with the section of the power source box.

5. The Projector Lamp Module according to claim 1, wherein said power source box is electrically connected to each Light Emitting Diode Projector Lamp in a waterproof plug-in mode.

6. The Projector Lamp Module according to claim 1, wherein said Projector Lamp comprises a Light Emitting Diode light source equipped inside the lamp box, a radiator equipped at the back-end of the lamp box, and a heat sink equipped at the front-end of the Light Emitting Diode light source.
